(19) United States
(12) Patent Application Publication
(10) Pub. No.: US 2024/0192514 A1
(43) Pub. Date: Jun. 13, 2024

(54) BEAM COMBINING USING ROTATED VOLUME BRAGG GRATINGS

(71) Applicant: University of Central Florida Research Foundation, Inc., Orlando, FL (US)

(72) Inventors: Ivan Divliansky, Orlando, FL (US); Oussama Mhibik, Oviedo, FL (US)

(21) Appl. No.: 18/532,629

(22) Filed: Dec. 7, 2023

Related U.S. Application Data
(60) Provisional application No. 63/430,805, filed on Dec. 7, 2022.

(51) Int. Cl. G02B 27/10

(52) U.S. Cl. CPC G02B 27/1006

(57) ABSTRACT

A beam combiner may include one or more light sources providing two or more input beams along two or more incidence paths and one or more rotated volume Bragg gratings (r-VBGs), where each of the r-VBGs is formed as planes of refractive index variation with periodicity along a respective grating vector at a respective non-zero angle relative to a respective one of the incidence paths of a respective one of the input beams, where the r-VBGs direct the two or more input beams along a common output path through at least one of transmission or reflection via Bragg reflection, and where at least one of the r-VBGs reflects a portion of at least one of the input beams satisfying a Bragg condition and having a polarization normal to a diffraction plane formed by a respective incidence path and the respective grating vector.

### CROSS-REFERENCE TO RELATED APPLICATION

The present application claims the benefit under 35 U.S.C. § 119(e) of U.S. Provisional Application Ser. No. 63/430,805, filed Dec. 7, 2022, which is incorporated herein by reference in the entirety.

### TECHNICAL FIELD

The present disclosure relates generally to beam combining and, more particularly, to beam combining incorporating rotated volume Bragg gratings.

### BACKGROUND

Beam combiners may combine light from different sources to a common output path. Spectral beam combiners may further combine light of different wavelengths to a common output path. However, typical spectral beam combiners require multiple elements, which may require precise alignment and may be sensitive to vibrations and other mechanical movements. There is therefore a need to develop systems and methods to address the above deficiencies.

### SUMMARY

A beam combining device is disclosed in accordance with one or more embodiments of the present disclosure. In embodiments, the device includes one or more light sources providing two or more input beams along two or more incidence paths. In embodiments, the device includes one or more rotated volume Bragg gratings (r-VBGs), where each of the r-VBGs is formed as planes of refractive index variation with periodicity along a respective grating vector at a respective non-zero angle relative to a respective one of the incidence paths of a respective one of the input beams, where the r-VBGs direct the two or more input beams along a common output path through at least one of transmission or reflection via Bragg reflection, where at least one of the r-VBGs reflects a portion of at least one of the input beams satisfying a Bragg condition and having a polarization normal to a diffraction plane formed by a respective incidence path and the respective grating vector.

In embodiments, one of the input beams has a respective incidence path aligned with the common output path and is transmitted by the r-VBGs.

In embodiments, the one or more r-VBGs includes one or more uniform r-VBGs with uniform periods along the respective grating vectors.

In embodiments, a particular one of the uniform r-VBGs reflects one or more of the input beams having a common wavelength along the common output path.

In embodiments, the one or more r-VBGs includes one or more chirped r-VBGs with periods chirped to vary along the respective grating vectors.

In embodiments, the Bragg condition is satisfied for different wavelengths at different locations for a particular one of the chirped r-VBGs, where the particular one of the chirped r-VBGs reflects one or more of the input beams with wavelengths and respective incidence paths oriented to satisfy the Bragg condition for reflection along the common output path.

In embodiments, the one or more r-VBGs includes one or more chirped r-VBGs with periods chirped to vary along the respective grating vectors.

In embodiments, the one or more r-VBGs include two or more r-VBGs formed in a common volume of a material.

In embodiments, the two or more r-VBGs formed in the common volume of the material have common grating vectors but different distributions of a respective period of the refractive index variation.

In embodiments, the two or more r-VBGs formed in the common volume of the material have different grating vectors.

In embodiments, the one or more r-VBGs include at least two r-VBGs formed in different materials.

A method is disclosed in accordance with one or more illustrative embodiments of the present disclosure. In embodiments, the method includes generating two or more input beams with one or more light sources, where the two or more input beams propagate along two or more incidence paths. In embodiments, the method includes combining, with one or more rotated volume Bragg gratings (r-VBGs) through at least one of transmission or reflection via Bragg reflection, the two or more input beams to propagate along a common output path, where each of the r-VBGs is formed as planes of refractive index variation with periodicity along a respective grating vector at a respective non-zero angle relative to a respective one of the incidence paths of a respective one of the input beams, where at least one of the r-VBGs reflects a portion of at least one of the input beams satisfying a Bragg condition and having a polarization normal to a diffraction plane formed by a respective incidence path and the respective grating vector.

In embodiments, one of the input beams has a respective incidence path aligned with the common output path and is transmitted by the r-VBGs.

In embodiments, the one or more r-VBGs includes one or more uniform r-VBGs with uniform periods along the respective grating vectors.

In embodiments, a particular one of the uniform r-VBGs reflects one or more of the input beams having a common wavelength along the common output path.

In embodiments, the one or more r-VBGs includes one or more chirped r-VBGs with periods chirped to vary along the respective grating vectors.

In embodiments, the Bragg condition is satisfied for different wavelengths at different locations for a particular one of the chirped r-VBGs, where the particular one of the chirped r-VBGs reflects one or more of the input beams with wavelengths and respective incidence paths oriented to satisfy the Bragg condition for reflection along the common output path. In embodiments, the one or more r-VBGs includes one or more chirped r-VBGs with periods chirped to vary along the respective grating vectors.

In embodiments, the one or more r-VBGs include two or more r-VBGs formed in a common volume of a material.

In embodiments, the two or more r-VBGs formed in the common volume of the material have common grating vectors but different distributions of a respective period of the refractive index variation.

In embodiments, the two or more r-VBGs formed in the common volume of the material have different grating vectors.

In embodiments, the one or more r-VBGs include at least two r-VBGs formed in different materials.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a top view of a rotated volume Bragg grating (r-VBG) with a uniform period, in accordance with one or more embodiments of the present disclosure.

FIG. 1B is a perspective view of the r-VBG of FIG. 1A, in accordance with one or more embodiments of the present disclosure.

FIG. 1C is a top view of an r-VBG with linear chirp along the grating vector direction, in accordance with one or more embodiments of the present disclosure.

FIG. 1D is a top view of a material including two multiplexed r-VBGs with a common grating vector direction, in accordance with one or more embodiments of the present disclosure.

FIG. 1E is a top view of a material including two multiplexed r-VBGs with different grating vector directions but common periods along the respective grating vector directions, in accordance with one or more embodiments of the present disclosure.

FIG. 1F is a top view of a material including two multiplexed chirped r-VBGs with different grating vector directions, in accordance with one or more embodiments of the present disclosure.

FIG. 2A is a simplified schematic depicting the polarization performance of an r-VBG with a uniform period of refractive index variation, in accordance with one or more embodiments of the present disclosure.

FIG. 2B is a simplified schematic depicting a plot of transmission of linearly-polarized input light through an r-VBG with a uniform period of refractive index variations in units of percentage, in accordance with one or more embodiments of the present disclosure.

FIG. 2C is a plot of reflection of linearly-polarized input light through an r-VBG with a chirped distribution of refractive index variations in units of percentage, in accordance with one or more embodiments of the present disclosure.

FIG. 3 is a block diagram of an optical source including one or more r-VBGs 100, in accordance with one or more embodiments of the present disclosure.

FIG. 4A is a simplified schematic of a beam combiner including a uniform r-VBG, in accordance with one or more embodiments of the present disclosure.

FIG. 4B is a simplified schematic of a beam combiner including a chirped r-VBG, in accordance with one or more embodiments of the present disclosure.

FIG. 4C is a simplified schematic of a beam combiner including multiplexed chirped r-VBGs, in accordance with one or more embodiments of the present disclosure.

FIG. 4D is a simplified schematic of a beam combiner including cascaded r-VBGs, in accordance with one or more embodiments of the present disclosure.

FIG. 5 is a flow diagram illustrating steps performed in a method for beam combining, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing beam combining using one or more rotated volume Bragg gratings (r-VBGs). As used herein an r-VBG is formed as a VBG having a grating vector direction of the rotated relative to an input face of a material or an expected direction of incident light.

VBGs are generally described in Igor V. Ciapurin, et al., “Modeling of phase volume diffractive gratings, part 1: transmitting sinusoidal uniform gratings,” Optical Engineering 45 (2006) 015802, 1-9; and Igor V. Ciapurin, et al., “Modeling of phase volume diffractive gratings, part 2: reflecting sinusoidal uniform gratings, Bragg mirrors,” Optical Engineering 51 (2012) 058001, 1-10, both of which are incorporated herein by reference in their entireties. Further, transmissive VBGs (e.g., VBGs for which light satisfying a Bragg condition is diffracted as a transmitted beam) configured as transmissive phase masks are described generally in U.S. Patent Publication No. 2016/0116656 published on Apr. 28, 2016, which is incorporated herein by reference in its entirety.

Various designs of beam combiners incorporating one or more r-VBGs are contemplated herein. For example, a beam combiner may include a uniform r-VBG with a refractive index variation having a uniform (e.g., constant) period along its grating vector. Such a configuration may effectively combine multiple input beams of a common wavelength. As another example, a beam combiner may include a chirped r-VBG with refractive index variation having a chirped (e.g., variable) period along its grating vector. Such a configuration may be effectively combine multiple input beams with different wavelengths. In a chirped r-VBG, a Bragg condition for reflection may be satisfied at different locations of the device. Input beams with different wavelengths may thus be positioned accordingly such that all beams are reflected to a common output direction.

In some embodiments, a beam combiner incorporates multiple r-VBGs with any combination of uniform or chirped refractive index variations. For example, multiple r-VBGs of any type may be formed within a common volume (e.g., multiplexed) of a material or formed in different materials (e.g., cascaded).

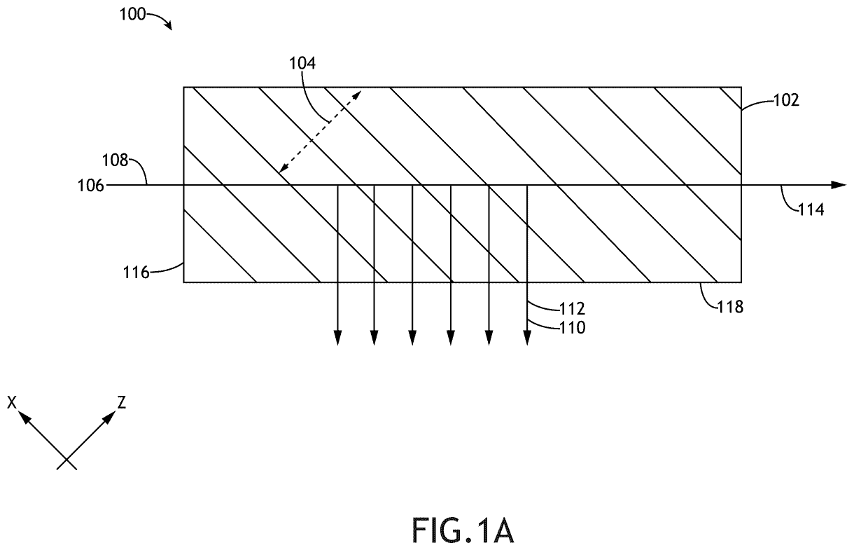

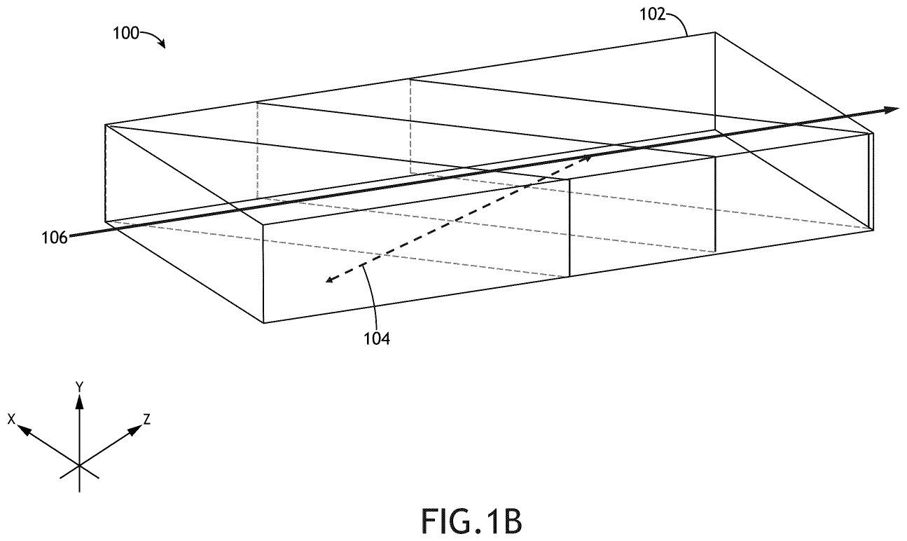

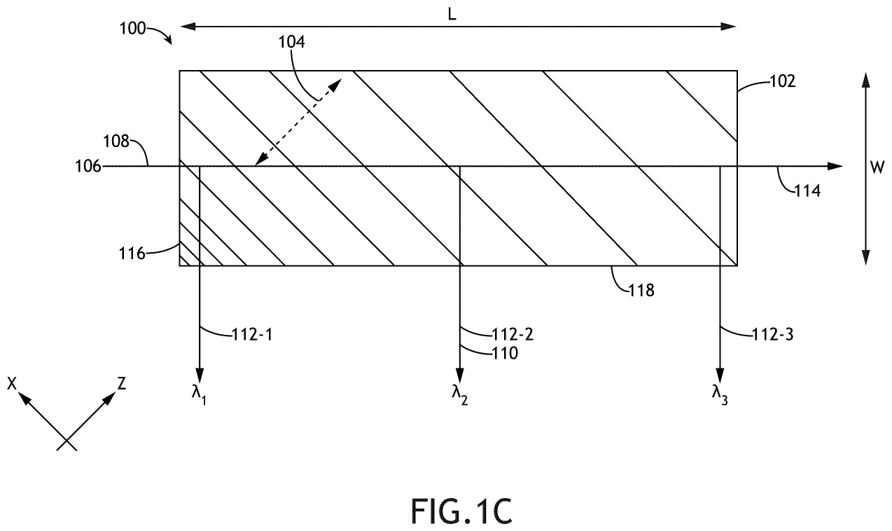

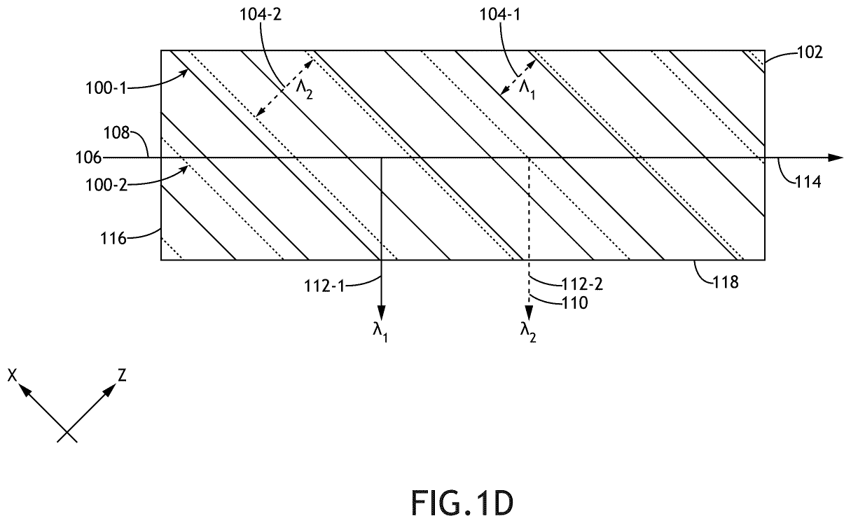

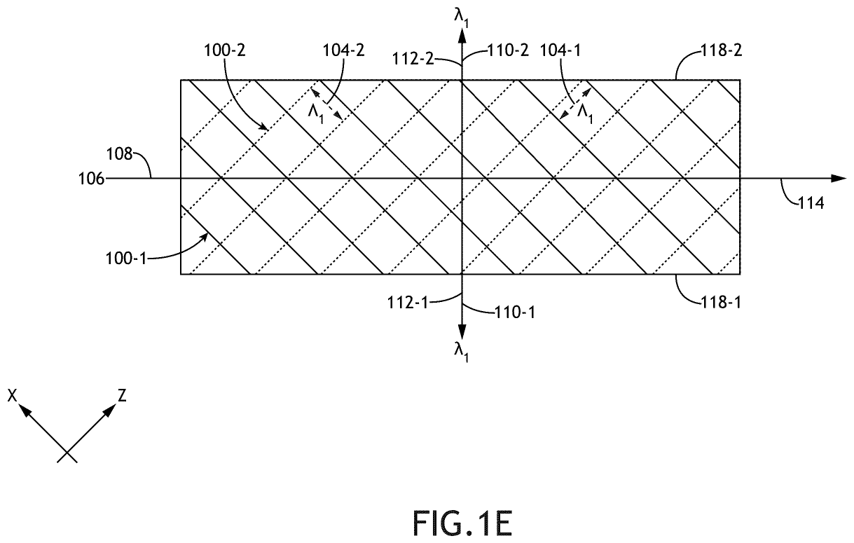

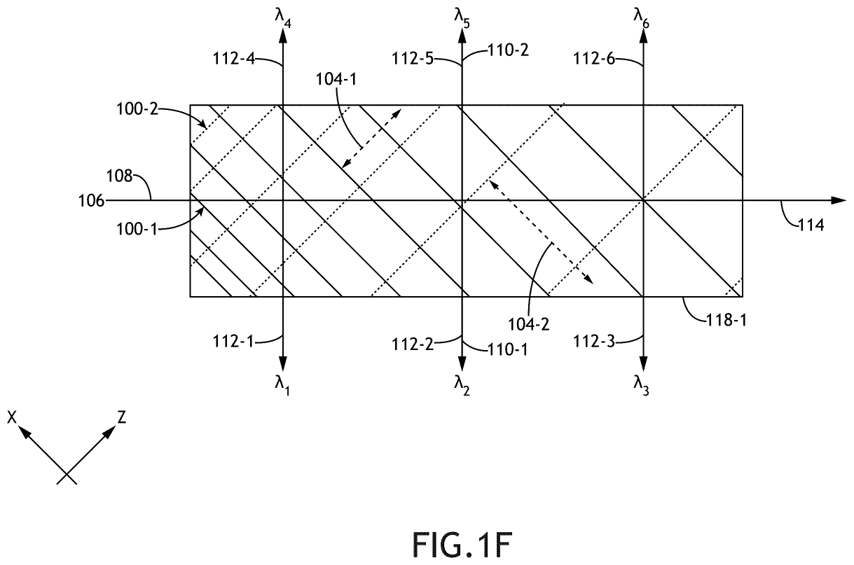

Referring now to FIGS. 1A-5, systems and methods for polarization control with an r-VBG are described in greater detail, in accordance with one or more embodiments of the present disclosure.

FIGS. 1A-1E illustrate the propagation of light of through an r-VBG 100, in accordance with one or more embodiments of the present disclosure.

A VBG may be formed as a grating structure associated within the volume of material 102 with a periodic variation of refractive index along a grating vector direction 104 k=2π/d. The material may include a photosensitive material or any other suitable material. This grating structure is typically extended in directions perpendicular to the grating vector direction 104. Put another way, a VBG may typically have a constant refractive index within any plane normal to the grating vector direction 104, where the refractive index along the grating vector direction 104 varies periodically. Further, a VBG may generally have any selected variation of the refractive index along the grating vector direction 104 so long as a Bragg condition is satisfied for at least one wavelength in at least a portion of the VBG. For example, the refractive index n of a traditional VBG may be a simple sinusoidal function with a constant (e.g., uniform) period along the grating vector direction 104. As another example, the refractive index n of a chirped VBG may have a variable period along the grating vector direction 104 and may thus satisfy a Bragg condition for different wavelengths at different locations. As another example, the refractive index variation (δn) of an apodized VBG may vary along the grating vector direction 104.

An r-VBG 100 may then be formed as a VBG with a grating vector direction 104 oriented at an angle from an expected incidence direction 106 of input light 108 (e.g., an input beam) or at an angle with respect to an input face 116 of the material in which the VBG is formed. Similarly, an r-VBG 100 may generally have any refractive index distribution along the grating vector direction 104 that satisfies a Bragg condition for light of at least one wavelength incident along the incidence direction 106.

FIG. 1A is a top view of an r-VBG 100 with a uniform period, in accordance with one or more embodiments of the present disclosure. FIG. 1B is a perspective view of the r-VBG 100 of FIG. 1A, in accordance with one or more embodiments of the present disclosure.

In FIGS. 1A and 1B, the grating vector direction 104 corresponds to a Z axis. The refractive index variation of the r-VBG 100 depicted in FIGS. 1A and 1B may then be characterized as:

$$n ( z ) = {n}_{0} + δ n cos ( \frac{2 π}{{Λ}_{0}} \cdot z ) \qquad ( 1 )$$

where n₀ is an average refractive index of a material 102 in which the r-VBG 100 is formed, δn is a refractive index contrast, and Λ₀ is a period of the refractive index variation along the grating vector direction 104. Further, the refractive index at any particular value of z may be constant along a corresponding plane orthogonal to the grating vector direction 104 (e.g., an X-Y plane). It is noted that the figures depict variations of refractive index along the grating vector direction 104 as simple lines, but this is merely illustrative and should not be interpreted as limiting the scope of the present disclosure. It is to be understood that Equation (2) is merely illustrative and not limiting on the scope of the present disclosure. Rather, an r-VBG 100 may include any refractive index distribution suitable for reflecting light via Bragg reflection. For example, as will be described in greater detail below, the period of the refractive index variation (Λ₀) may vary along the grating vector direction 104 (e.g., forming a chirped r-VBG 100). As another example, the refractive index contrast (δn) may also vary along the grating vector direction 104, which is referred to herein as apodization such that an r-VBG 100 with a refractive index contrast (δn) that varies along the grating vector direction 104 is an apodized r-VBG 100. In this configuration, the diffraction efficiency may also vary along the grating vector direction 104.

An r-VBG 100 may reflect light via Bragg diffraction when a Bragg condition is satisfied for a particular wavelength and incidence direction 106 and transmit light otherwise. For example, FIGS. 1A and 1B depict input light 108 along an incidence direction 106, where a portion of the input light 108 is reflected via Bragg diffraction along a reflection direction 110 (e.g., as reflected light 112) and a portion of the input light 108 is transmitted along the input light 108 (e.g., as transmitted light 114). Notably, the incidence direction 106 and the reflection direction 110 lie within a diffraction plane (e.g., a plane of diffraction) formed by the grating vector direction 104 and the incidence direction 106. In FIGS. 1A and 1B, the diffraction plane corresponds to the X-Z plane. Notably, reflected light 112 and transmitted light 114 also lie within the diffraction plane.

The reflected light 112 may be spatially extended (e.g., spatially chirped) along the incidence direction 106 as demonstrated in FIG. 1A. The extent of the spatial chirp along the incidence direction 106 may depend on various factors such as, but not limited to, a diffraction efficiency of Bragg diffraction that produces the reflected light 112. In this way, the depiction of six rays of reflected light 112 in FIG. 1A is merely illustrative and should not be interpreted as limiting the present disclosure. Further, the depiction of the location of the reflected light 112 along the incidence direction 106 is also merely illustrative and should not be interpreted as limiting the present disclosure. Some figures depict reflected light 112 as a single ray, but this is again for illustrative purposes and should not be interpreted as limiting the present disclosure.

The reflected wavelength (e.g., a wavelength at which a Bragg condition is satisfied) may be characterized by:

λ(ϕ)=2Λ₀\sqrt{n₀²−sin² ϕ} (2)

where ϕ is an angle between the grating vector direction 104 and an incidence direction 106. Equation (2) illustrates that the reflected wavelength decreases as the angle ϕ increases between 0 and 45 degrees. Further, for the particular case of ϕ=45°, the reflected wavelength is λ(45°)=\sqrt{2}Λ₀n₀.

It is contemplated herein that the material 102 in which an r-VBG 100 is formed may have any shape and/or any number of faces at any orientation with respect to the grating vector direction 104. In some embodiments, an r-VBG 100 and one or more faces of the material 102 are co-designed to provide that light propagates normally through one or more faces. Such a configuration may be useful for, but not limited to, mitigating dispersion at the face. For example, as depicted in FIG. 1A, the grating vector direction 104 may be oriented at a non-zero angle with respect to a normal of an input face 116, which may be suitable for, but not limited to, applications in which input light 108 is expected to propagate through the input face 116 at normal incidence. As another example, as also depicted in FIG. 1A, an output face 118 may be oriented such that reflected light 112 (e.g., of a known wavelength based on a known incidence direction 106) exits the material 102 through the output face 118 at normal incidence.

Referring now to FIG. 1C, the properties of an r-VBG 100 with a non-uniform refractive index distribution along the grating vector direction 104 (e.g., a chirped distribution) is described.

As indicated previously herein, an r-VBG 100 may generally have any refractive index distribution along the grating vector direction 104 that satisfies a Bragg condition for light of at least one wavelength propagating along an incidence direction 106 that is different than the grating vector direction 104. In some embodiments, a period of the refractive index variation varies monotonically along the grating vector direction 104 (e.g., monotonically increases or decreases). For example, the period may vary linearly, quadratically, or by any other distribution. An r-VBG 100 with a non-uniform refractive index variation along the grating vector direction 104 may be referred to as a rotated chirped Volume Bragg grating and may be abbreviated as r-CVBG or r-CBG.

FIG. 1C is a top view of an r-VBG 100 with linear chirp along the grating vector direction 104, in accordance with one or more embodiments of the present disclosure. For example, the refractive index variation of an r-VBG 100 with linear chirp may be characterized as:

$$n ( z ) = {n}_{0} + δ n cos \{ Q z + {β ( z - 0.5 L )}^{2} \} \\ where Q \approx \frac{4 π}{{λ}_{0}} {n}_{0} , \qquad ( 3 )$$

β is a chirp rate, and L is a length of the r-VBG 100 along the incidence direction 106.

In this configuration, different wavelengths are reflected by the r-VBG 100 at different depths along the incidence direction 106. Put another way, the Bragg condition may be satisfied for different wavelengths at different depths along the incidence direction 106. This is illustrated in FIG. 1C by a first ray of reflected light 112-1 with a first wavelength λ₁ at a first depth along the incidence direction 106, a second ray of reflected light 112-2 with a second wavelength λ₂ at a second depth along the incidence direction 106, and a third ray of reflected light 112-3 with a third wavelength λ₃ at a third depth along the incidence direction 106. More particularly, it can be shown for the configuration of FIG. 1C that the reflected wavelength may be characterized as:

$$λ ( z ) = {λ}_{0} - γ z , and \qquad ( 4 )$$

$$γ = \frac{{λ}_{0}^{2}}{2 π {n}_{0}} β , \qquad ( 5 )$$

where λ₀ is a first reflected wavelength.

As a result, the reflected light 112 may be spectrally chirped (e.g., spectrally resolved) along the incidence direction 106 and also temporally chirped due to the difference in path lengths as a function of wavelength. A spectrally resolved bandwidth Δλ (e.g., a resolution of the r-VBG 100) may be characterized as:

$$Δ λ = \frac{{n}_{0} \vert γ \vert}{\sqrt{{n}_{0}^{2} - {sin}^{2} ϕ}} \cdot L . \qquad ( 6 )$$

Accordingly, the resolved bandwidth may generally be increased by increasing the length of the r-VBG 100 along the incidence direction 106 (L). The primary constraint on the width W of the r-VBG 100 orthogonal to the incidence direction 106 is diffraction as it propagates along the incidence direction 106.

Referring now to FIGS. 1D-1F, the fabrication of multiple r-VBGs 100 within a common volume of material 102 (e.g., multiplexed fabrication) is described in greater detail, in accordance with one or more embodiments of the present disclosure.

In a general sense, any number of r-VBGs 100 of any type (e.g., uniform, chirped, apodized, or the like) may be fabricated in a common volume of a material 102. Further, each r-VBG 100 may have a grating vector direction 104 along any selected direction. For example, multiple r-VBGs 100 may be fabricated within a common volume that have a common grating vector direction 104 but different refractive index distributions along the common grating vector direction 104 (e.g., different uniform periods, different chirp rates, or the like). Such a configuration may be suitable for, but not limited to, generating multiple beams of reflected light 112 out of a single output face. As another example, multiple r-VBGs 100 may be fabricated within a common volume that have different grating vector directions 104, where the r-VBGs 100 may have the same or different refractive index distributions along the respective grating vector directions 104. Such a configuration may be suitable for, but not limited to, generating multiple beams of reflected light 112 that propagate along different directions and potentially out of different output faces.

FIG. 1D is a top view of a material 102 including two multiplexed r-VBGs 100 with a common grating vector direction 104, in accordance with one or more embodiments of the present disclosure. In FIG. 1D, a first r-VBG 100-1 is substantially similar to FIG. 1A and has a first uniform period Λ₁ along a first grating vector direction 104-1, while a second r-VBG 100-2 has a second uniform period Λ₂ along a second grating vector direction 104-2 oriented parallel to the first grating vector direction 104-1. FIG. 1D further depicts input light 108, reflected light 112-1 corresponding to a first wavelength λ₁ (shown as solid lines) that is reflected by the first r-VBG 100-1 (e.g., the first wavelength λ₁ satisfies a Bragg condition for the first r-VBG 100-1), and a second beam of reflected light 112-2 corresponding to a second wavelength λ₂ (shown as dashed lines) that is reflected by the second r-VBG 100-2 (e.g., the second wavelength λ₂ satisfies a Bragg condition for the second r-VBG 100-2). Notably, the reflected light 112-1 and the reflected light 112-2 exit from the same output face 118. Further, the reflected light 112-1 and the reflected light 112-2 are each shown as single rays for clarity. However, as illustrated in FIG. 1A, the reflected light 112-1 and/or the reflected light 112-2 may be spatially chirped along the incidence direction 106.

FIG. 1E is a top view of a material 102 including two multiplexed r-VBGs 100 with different grating vector directions 104 but common periods Λ₁ along the respective grating vector directions 104, in accordance with one or more embodiments of the present disclosure. In FIG. 1E, a first r-VBG 100-1 has a first grating vector direction 104-1 oriented to provide reflected light 112-1 along a first reflection direction 110-1. A second r-VBG 100-2 has a second grating vector direction 104-2 oriented to provide reflected light 112-2 along a second reflection direction 110-2. FIG. 1E depicts a particular configuration in which the first grating vector direction 104-1 is orthogonal to the second grating vector direction 104-2 and both grating vector direction 104 are oriented at 45-degrees relative to the incidence direction 106. In this configuration, the reflected light 112-1 exits from a first output face 118-1 and the reflected light 112-2 exits from a second output face 118-2. Further, the reflected light 112-1 and the reflected light 112-2 from the two r-VBGs 100 have the same wavelength. Configurations such as this in which multiplexed r-VBGs 100 have grating vector directions 104 oriented with both positive and negative angles with respect to the incidence direction 106 to provide reflected light 112 from different output faces 118 (e.g., output faces 118-1,118-2) are referred to herein as an X-configuration. However, it is to be understood that FIG. 1E and the associated description are merely illustrative and should not be interpreted as limiting the scope of the present disclosure. Multiplexed r-VBGs 100 may generally have any grating vector directions 104, which may result in potentially different wavelengths of associated reflected light 112 along associated reflection directions.

FIG. 1F is a top view of a material 102 including two multiplexed chirped r-VBGs 100 with different grating vector directions 104, in accordance with one or more embodiments of the present disclosure. In particular, FIG. 1F depicts a first r-VBG 100-1 with a first refractive index distribution along a first grating vector direction 104-1 and a second refractive index distribution along a second r-VBG 100-2 with second grating vector direction 104-2. As in FIG. 1E, the first grating vector direction 104-1 is orthogonal to the second grating vector direction 104-2 and oriented at 45-degrees relative to the incidence direction 106. In this way, the first r-VBG 100-1 may generate first reflected light 112 (shown as rays of reflected light 112-1 through 112-3) having a first wavelength distribution (represented as λ₁ through λ₃) that exits through a first output face 118-1, whereas the second r-VBG 100-2 may generate second reflected light 112 (shown as rays of reflected light 112-4 through 112-6) having a second wavelength distribution (represented as λ₄ through λ₆) that exits through a second output face 118-2. Again, the particular configuration depicted in FIG. 1F and the associated description are merely illustrative and should not be interpreted as limiting the scope of the present disclosure. In general, multiple r-VBGs 100 with different chirp distributions may have any grating vector directions 104 and may reflect light within any overlapping or non-overlapping spectral bands. Further, although not shown, any type of r-VBGs 100 may be multiplexed within a common volume including, but not limited to, uniform, chirped, or apodized r-VBGs 100.

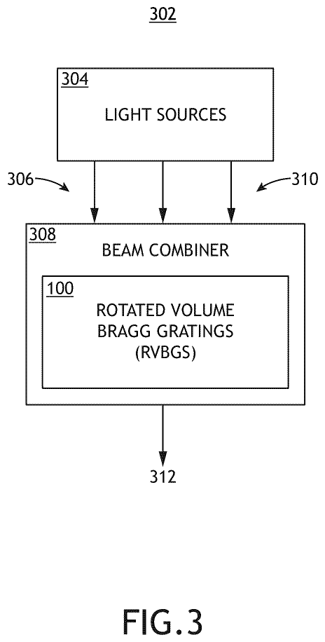

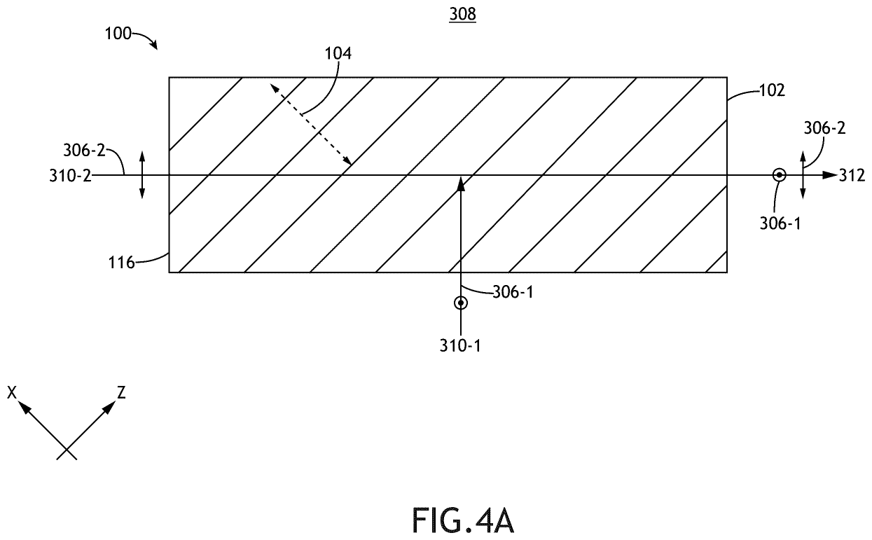

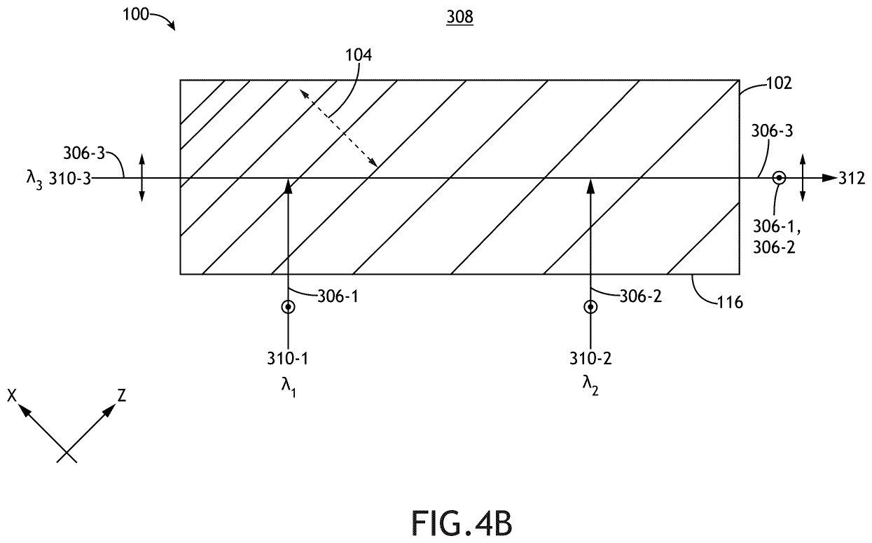

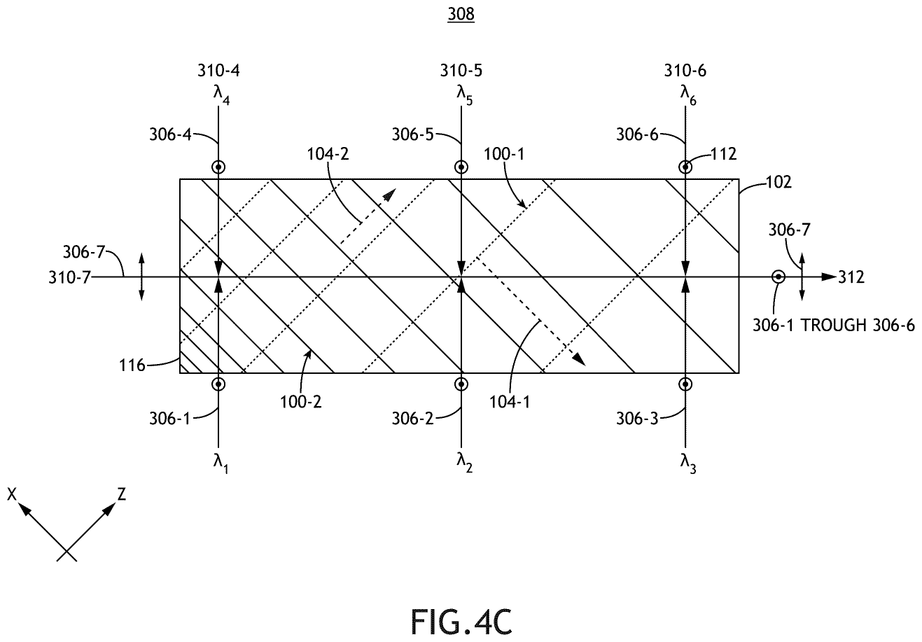

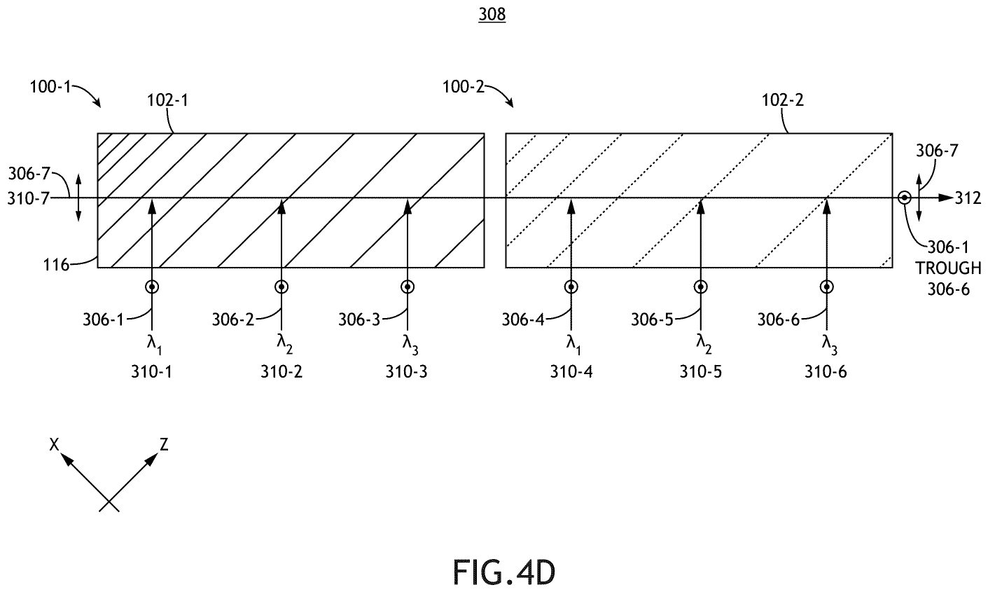

Referring generally to FIGS. 1C-1F, it is contemplated herein that a chirped r-VBG 100 may be well-suited for spectral beam combining. The same properties that allow a chirped r-VBG 100 to spatially resolve a spectrum of incident light also allow a chirped r-VBG 100 to combine incident light in reverse operation. For example, multiple input beams with different wavelengths may be directed to a chirped r-VBG 100 at positions selected to provide Bragg reflection of all beams into a common output path. Additional details and configurations are described with respect to FIGS. 3-4C herein.

An r-VBG 100 may be fabricated in any material 102 that has transparency for the wavelength or wavelengths of interest including, but not limited to, wavelengths in ultraviolet, visible, or infrared spectral regions. This includes but is not limited to glasses, crystals, polymers, sol-gels, and others. Further, an r-VBG 100 may be fabricated using any technique known in the art such as, but not limited to, holographic recording techniques or direct laser writing techniques (e.g., femtosecond laser direct writing techniques).

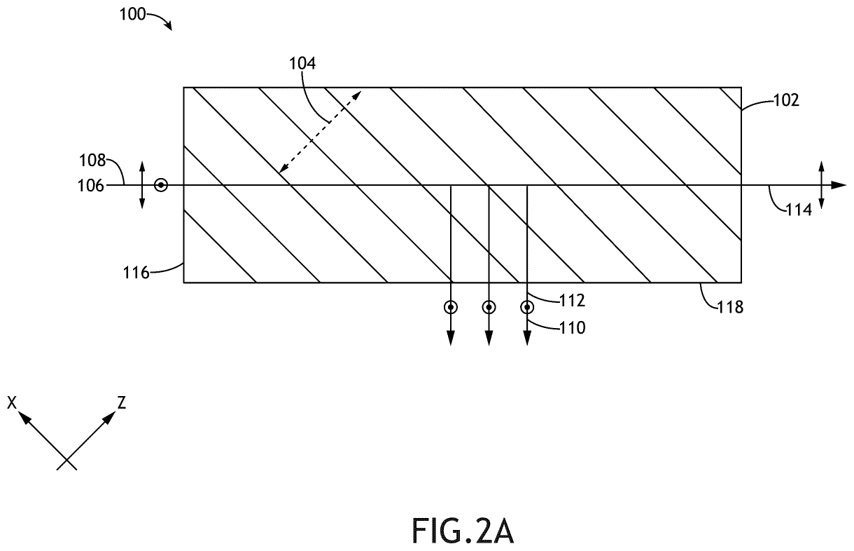

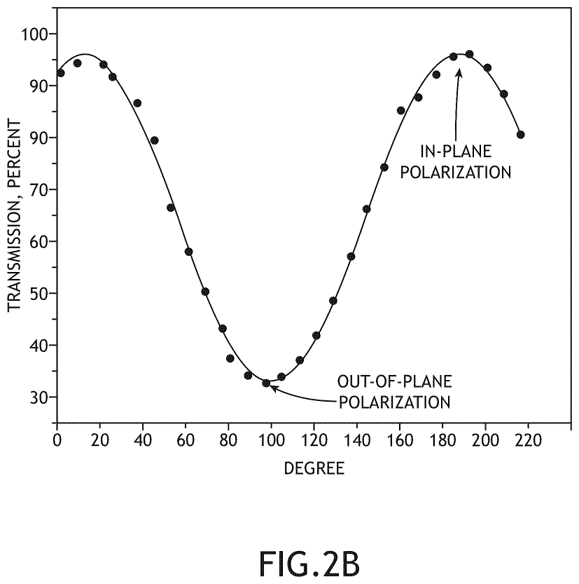

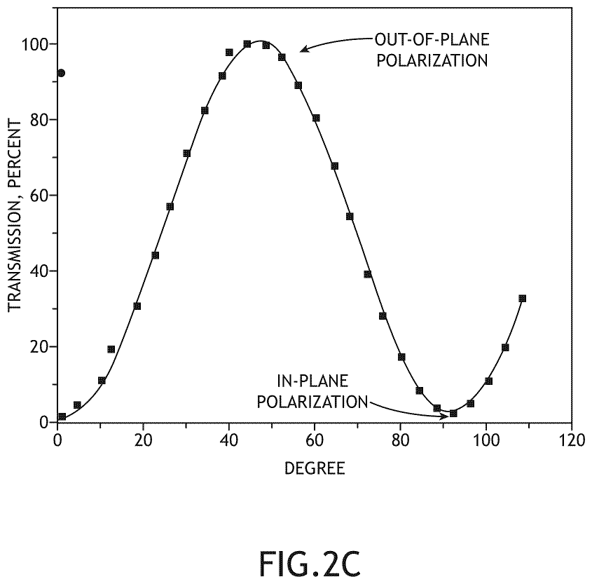

Polarization-dependent properties of r-VBGs 100 are now described in greater detail in FIGS. 2A-7.

It is contemplated herein that an r-VBG 100 may operate as a polarization-sensitive element. In particular, an r-VBG 100 may reflect light that satisfies a Bragg condition (e.g., light having a wavelength satisfying a resonance condition of the r-VBG 100), where the diffraction efficiency of this reflection is polarization sensitive. Further, this polarization-sensitive behavior may be present for any refractive index distribution including, but not limited to, a uniform refractive index distribution or a chirped refractive index distribution.

It is noted that polarization may be expressed according to different conventions or definitions. In the present disclosure, a convention is used in which a polarization of light incident on an r-VBG 100 is characterized relative to the diffraction plane (e.g., a plane formed by the incidence direction 106 and the reflection direction 110 which corresponds to the X-Y plane in FIGS. 1A-1G).

It is contemplated herein that a diffraction efficiency of reflected light 112 from an r-VBG 100 may be minimum for light having a polarization within the diffraction plane (referred to herein as in-plane-polarized light) and maximum for light with a polarization orthogonal to the diffraction plane (referred to herein as out-of-plane-polarized light). As a result, an r-VBG 100 may isolate in-plane-polarized light from out-of-plane-polarized light.

FIG. 2A is a simplified schematic depicting the polarization performance of an r-VBG 100 with a uniform period of refractive index variation, in accordance with one or more embodiments of the present disclosure. In FIG. 2A, input light 108 is shown has having both in-plane and out-of plane polarization. Portions of the input light 108 having in-plane polarization are transmitted as transmitted light 114, whereas portions of the input light 108 having out-of-plane polarization that satisfy a Bragg condition are reflected as reflected light 112. Remaining portions of the input light 108 are transmitted through the r-VBG 100 as transmitted light 114. For example, the transmitted light 114 may include portions of the input light 108 having in-plane polarization as well as portions of the input light 108 having out-of-plane polarization but wavelengths at which a Bragg condition is not satisfied.

FIG. 2B is a simplified schematic depicting a plot of transmission of linearly-polarized input light 108 through an r-VBG 100 with a uniform period of refractive index variations in units of percentage, in accordance with one or more embodiments of the present disclosure. The plot in FIG. 2B is generated by rotating the polarization of the input light 108 with a half-wave plate, where the X-axis of the plot corresponds to polarization direction of the input light 108. As shown in FIG. 2B, the r-VBG 100 provides high transmission when the input light 108 is in-plane polarized and low transmission (e.g., high reflection) when the input light 108 is out-of-plane polarized.

FIG. 2C is a plot of reflection of linearly-polarized input light 108 through an r-VBG 100 with a chirped distribution of refractive index variations in units of percentage, in accordance with one or more embodiments of the present disclosure. Similar to FIG. 2B, the plot in FIG. 2C is generated by rotating the polarization of the input light 108 with a half-wave plate, where the X-axis of the plot corresponds to polarization direction of the input light 108. As shown in FIG. 2C, the r-VBG 100 provides high reflection when the input light 108 is out-of-plane polarized and low reflection (e.g., high transmission) when the input light 108 is in-plane polarized. Notably, the values of the polarization direction on the X axes of FIGS. 2B and 2C are not synchronized. Rather, the in-plane and out-of-plane directions are noted by arrows in the figures. Taken together, FIGS. 2B and 2C illustrate polarization-sensitive performance of both uniform and chirped r-VBGs 100. It is noted that FIGS. 2B and 2C depict some losses, which may be due to errors in a fabrication process. In general, the transmission and/or reflection characteristics (or alternatively an extinction ratio) that may be achieved may depend on the particular characteristics of a fabricated device, the angle of the grating vector direction 104 relative to the incidence direction 106, a diffraction efficiency of the grating, the polarization, the chirp rate (in case the grating is chirped), which may be tuned for different applications.

More generally, the orientation/rotation r-VBG 100 may impact the reflection/diffraction efficiency such that FIGS. 2B-2C are merely illustrative. The reflection efficiency also depends on the length of the grating, on its refractive index modulation, and on its period. The grating itself could be uniform, apodised or chirped. An r-VBG 100 with a uniform periodic refractive index variation may operate at much narrower spectral region compared to a chirped r-VBG 100. A chirped r-VBG 100 may also operate at multiple discrete wavelengths (with certain spectral width on their own) or with sources having broad emission.

Referring now to FIGS. 3-4D, beam combining with one or more r-VBGs 100 is described in greater detail, in accordance with one or more embodiments of the present disclosure.

FIG. 3 is a block diagram of an optical source 302 including one or more r-VBGs 100, in accordance with one or more embodiments of the present disclosure.

In some embodiments, an optical source 302 includes one or more light sources 304 configured to generate two or more input beams 306. The input beams 306 may have any selected spectra. For example, the input beams 306 may be, but are not required to be, narrowband beams characterized by a central wavelength. For the purposes of illustration, the examples herein refer to various wavelengths of the input beams 306 to illustrate the spectral properties of r-VBGs 100. Such examples may refer to central wavelengths or wavelengths of interest within a broader spectrum. However, such examples are merely illustrative and should not be interpreted as limiting the scope of the present disclosure. Rather, the teachings and examples herein may be extended to input beams 306 with any spectra.

The input beams 306 may each have any selected spectrum or wavelengths of interest. For example, at least two of the input beams 306 may have a common wavelength. As another example, at least two of the input beams 306 may have different wavelengths.

In some embodiments, an optical source 302 includes a beam combiner 308 including one or more r-VBGs 100 formed within the volumes of one or more materials 102. The optical source 302 may include any combination of uniform r-VBGs 100 or chirped r-VBGs 100 in any single, multiplexed, or cascaded configurations suitable for combining the input beams 306 from various incidence paths 310 to a common output path 312. Further, light along the common output path 312 associated with the input beams 306 may be collimated or may propagate in parallel.

FIGS. 4A-4D depict various non-limiting configurations of a beam combiner 308 including one or more r-VBGs 100, in accordance with one or more embodiments of the present disclosure.

FIG. 4A is a simplified schematic of a beam combiner 308 including a uniform r-VBG 100, in accordance with one or more embodiments of the present disclosure.

In FIG. 4A, a first input beam 306-1 with out-of-plane polarization (e.g., orthogonal to a diffraction plane of an r-VBG 100) propagates along a first incidence path 310-1 and is reflected along a common output path 312 via Bragg reflection (e.g., corresponding to reflected light 112 as illustrated in FIGS. 1A-1F). It is noted that a width of the reflected portion of the first input beam 306-1 may be extended along a direction associated with the first incidence path 310 as depicted in FIG. 1A.

Additionally, a second input beam 306-2 with in-plane polarization (e.g., within the diffraction plane) propagates along a second incidence path 310-2 that is aligned with the common output path 312. As a result, the second input beam 306-2 is transmitted by the r-VBG 100 (e.g., as described with respect to FIGS. 2A-2C) and emerges along the common output path 312.

In this configuration, the wavelength and incidence path 310 of the second input beam 306-2 must satisfy a condition for Bragg reflection. However, the first input beam 306 may generally have any wavelength since it is simply transmitted through the r-VBG 100.

FIG. 4B is a simplified schematic of a beam combiner 308 including a chirped r-VBG 100, in accordance with one or more embodiments of the present disclosure.

It is contemplated herein that a chirped r-VBG 100 may enable beam combining for multiple input beams 306 with different wavelengths through a common input face 116. For example, FIG. 4B depicts a first input beam 306-1 with a first wavelength λ₁ along a first incidence path 310-1 and a second input beam 306-2 with a second wavelength λ₂ along a second incidence path 310-2, both incident on a common input face 116. Both the first input beam 306-1 and the second input beam 306-2 have out-of-plane polarization for efficient reflection by the chirped r-VBG 100. Further, since the condition for Bragg reflection is satisfied at different locations in the material 102, the first incidence path 310-1 and the second incidence path 310-2 are arranged to provide that a Bragg condition is satisfied for reflection of the first input beam 306-1 and the second input beam 306-2 to the common output path 312. It is noted that this configuration may be extended to provide beam combining with any number of input beams 306 with different wavelengths and is not limited to two input beams 306 as depicted.

FIG. 4B also depicts a third input beam 306-3 with in-plane polarization propagating along a third incidence path 310-3 that is aligned with the common output path 312. As a result, the third input beam 306-3 is transmitted by the r-VBG 100 and emerges along the common output path 312. As described with respect to FIG. 4A, an input beam 306 with in-plane polarization (e.g., the third input beam 306-3 here) may have any wavelength. It is noted that such an input beam 306 with in-plane polarization is not necessary for all embodiments and beam combining may be achieved through Bragg reflection alone in some embodiments.

As described previously herein, multiple r-VBGs 100 may be multiplexed into a common volume of material 102, which may allow greater flexibility for orienting input beams 306 and/or allow combinations of greater numbers of input beams 306.

FIG. 4C is a simplified schematic of a beam combiner 308 including multiplexed chirped r-VBGs 100, in accordance with one or more embodiments of the present disclosure. In particular, FIG. 4C depicts a first r-VBG 100-1 to reflect input beam 306-1 through input beam 306-3 incident along incidence path 310-1 through incidence path 310-3 to the common output path 312 and a second r-VBG 100-2 to reflect input beam 306-4 through input beam 306-6 incident along incidence path 310-4 through incidence path 310-6 to the common output path 312. In particular, FIG. 4C depicts a configuration where a first grating vector direction 104-1 of the first r-VBG 100-1 is orthogonal to a second grating vector direction 104-2 of the second r-VBG 100-2. However, this is not a requirement and the grating vector directions 104 may be oriented in any manner suitable for providing Bragg reflection of the associated input beams 306 to the common output path 312. Additionally, though not shown, the configuration in FIG. 4C may be extended to include additional r-VBGs 100 with grating vector directions 104 outside of the X-Z plane. In a general sense, a beam combiner 308 may utilize any number of multiplexed r-VBGs 100.

FIG. 4C also depicts an in-plane polarized input beam 306-7 that may be transmitted through both the first r-VBG 100-1 and the second r-VBG 100-2. Again, such an in-plane input beam 306 may have any wavelength.

FIG. 4D is a simplified schematic of a beam combiner 308 including cascaded r-VBGs 100, in accordance with one or more embodiments of the present disclosure. FIG. 4D is substantially similar to FIG. 4C except that the first r-VBG 100-2 and the second r-VBG 100-2 are fabricated in different materials 102-1,102-2. However, in this configuration, the first r-VBG 100-1 and the second r-VBG 100-2 are arranged to provide a common output path 312. Further, the first r-VBG 100-1 and the second r-VBG 100-2 may be configured such that the combined beams from the first r-VBG 100-1 do not satisfy a Bragg condition in the second r-VBG 100-2 and thus may propagate through the second r-VBG 100-2 along the common output path 312. Additionally, FIG. 4D may be extended to provide any number of cascaded r-VBGs 100 distributed along the common output path 312.

Referring generally to FIGS. 4A-4D, it is to be understood that FIGS. 4A-4D are provided solely for illustrative purposes and should not be interpreted as limiting on the present disclosure. For example, any of the examples herein may be extended to any combination of uniform and chirped r-VBGs 100.

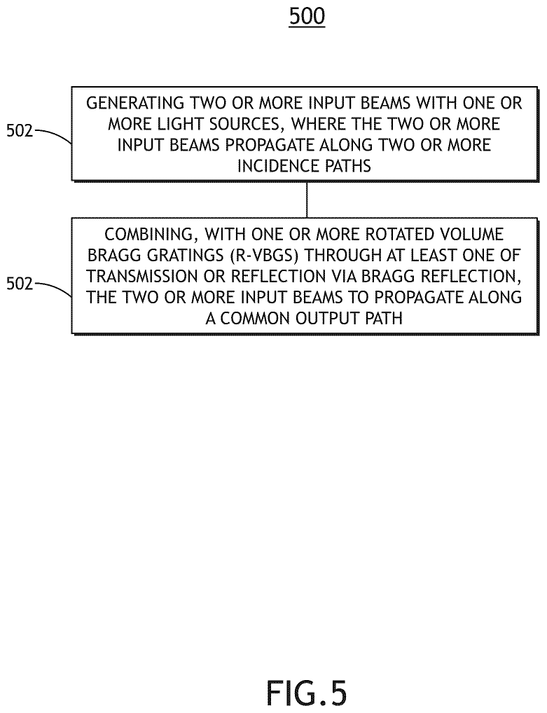

FIG. 5 is a flow diagram illustrating steps performed in a method 500 for beam combining, in accordance with one or more embodiments of the present disclosure. Applicant notes that the embodiments and enabling technologies described previously herein in the context of the optical source 302 should be interpreted to extend to the method 500. It is further noted, however, that the method 500 is not limited to the architecture of the optical source 302.

In some embodiments, the method 500 includes a step 502 of generating two or more input beams 306 with one or more light sources 304, where the two or more input beams 306 propagate along two or more incidence paths 310.

In some embodiments, the method 500 includes a step 504 of combining, with one or more r-VBGs 100 through at least one of transmission or reflection via Bragg reflection, the two or more input beams 306 to propagate along a common output path 312. The r-VBGs 100 may include any combination of uniform or chirped r-VBGs 100 in any combination of a single, multiplexed, or cascaded configuration.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A device comprising:
one or more light sources providing two or more input beams along two or more incidence paths; and
one or more rotated volume Bragg gratings (r-VBGs), wherein each of the r-VBGs is formed as planes of refractive index variation with periodicity along a respective grating vector at a respective non-zero angle relative to a respective one of the incidence paths of a respective one of the input beams, wherein the r-VBGs direct the two or more input beams along a common output path through at least one of transmission or reflection via Bragg reflection, wherein at least one of the r-VBGs reflects a portion of at least one of the input beams satisfying a Bragg condition and having a polarization normal to a diffraction plane formed by a respective incidence path and the respective grating vector.

2. The device of claim 1, wherein one of the input beams has a respective incidence path aligned with the common output path and is transmitted by the r-VBGs.

3. The device of claim 1, wherein the one or more r-VBGs includes one or more uniform r-VBGs with uniform periods along the respective grating vectors.

4. The device of claim 3, wherein a particular one of the uniform r-VBGs reflects one or more of the input beams having a common wavelength along the common output path.

5. The device of claim 1, wherein the one or more r-VBGs includes one or more chirped r-VBGs with periods chirped to vary along the respective grating vectors.

6. The device of claim 5, wherein the Bragg condition is satisfied for different wavelengths at different locations for a particular one of the chirped r-VBGs, wherein the particular one of the chirped r-VBGs reflects one or more of the input beams with wavelengths and respective incidence paths oriented to satisfy the Bragg condition for reflection along the common output path.

7. The device of claim 1, wherein the one or more r-VBGs includes one or more chirped r-VBGs with periods chirped to vary along the respective grating vectors.

8. The device of claim 1, wherein the one or more r-VBGs include two or more r-VBGs formed in a common volume of a material.

9. The device of claim 8, wherein the two or more r-VBGs formed in the common volume of the material have common grating vectors but different distributions of a respective period of the refractive index variation.

10. The device of claim 8, wherein the two or more r-VBGs formed in the common volume of the material have different grating vectors.

11. The device of claim 1, wherein the one or more r-VBGs include at least two r-VBGs formed in different materials.

12. A method comprising:
generating two or more input beams with one or more light sources, wherein the two or more input beams propagate along two or more incidence paths; and
combining, with one or more rotated volume Bragg gratings (r-VBGs) through at least one of transmission or reflection via Bragg reflection, the two or more input beams to propagate along a common output path, wherein each of the r-VBGs is formed as planes of refractive index variation with periodicity along a respective grating vector at a respective non-zero angle relative to a respective one of the incidence paths of a respective one of the input beams, wherein at least one of the r-VBGs reflects a portion of at least one of the input beams satisfying a Bragg condition and having a polarization normal to a diffraction plane formed by a respective incidence path and the respective grating vector.

13. The method of claim 12, wherein one of the input beams has a respective incidence path aligned with the common output path and is transmitted by the r-VBGs.

14. The method of claim 12, wherein the one or more r-VBGs includes one or more uniform r-VBGs with uniform periods along the respective grating vectors.

15. The method of claim 14, wherein a particular one of the uniform r-VBGs reflects one or more of the input beams having a common wavelength along the common output path.

16. The method of claim 12, wherein the one or more r-VBGs includes one or more chirped r-VBGs with periods chirped to vary along the respective grating vectors.

17. The method of claim 16, wherein the Bragg condition is satisfied for different wavelengths at different locations for a particular one of the chirped r-VBGs, wherein the particular one of the chirped r-VBGs reflects one or more of the input beams with wavelengths and respective incidence paths oriented to satisfy the Bragg condition for reflection along the common output path.

18. The method of claim 12, wherein the one or more r-VBGs includes one or more chirped r-VBGs with periods chirped to vary along the respective grating vectors.

19. The method of claim 12, wherein the one or more r-VBGs include two or more r-VBGs formed in a common volume of a material.

20. The method of claim 19, wherein the two or more r-VBGs formed in the common volume of the material have common grating vectors but different distributions of a respective period of the refractive index variation.

21. The method of claim 19, wherein the two or more r-VBGs formed in the common volume of the material have different grating vectors.

22. The method of claim 12, wherein the one or more r-VBGs include at least two r-VBGs formed in different materials.
